(19) United States
(12) Patent Application Publication
(10) Pub. No.: US 2020/0144835 A1
(43) Pub. Date: May 7, 2020

(54) MULTI-FUNCTIONAL ELECTRONIC DEVICE RECEIVING BAG

(71) Applicant: Yung-Hao Liu, New Taipei City (TW)

(72) Inventor: Yung-Hao Liu, New Taipei City (TW)

(21) Appl. No.: 16/182,633

(22) Filed: Nov. 7, 2018

(51) Int. Cl. H02J 7/00; H02J 7/02; G06F 1/26; A45C 11/00; A45C 15/00

(52) U.S. Cl. CPC H02J 7/0044; H02J 7/025; H02J 7/0054; H02J 7/027; A45C 2011/002; A45C 11/00; A45C 15/00; H02J 2007/0062; A45C 2011/003; G06F 1/263

(57) ABSTRACT

A multi-functional electronic device receiving bag includes a bag body having hollow space; a battery built in the bag body and combined to the bag body; a hub built in the bag body and combined to the bag body; the hub including an input port and at least one output port; the input port being connected to an electronic device so that through the input port and the output port of the hub, the electronic device can be connected to other electronic device; and a wireless power charging module built in the bag body; the wireless power charging module being electrically connected to the battery and then transferring power from the battery to an external electronic device wirelessly. The bag further includes at least one notebook conduction wire; at least one handset power wire; at least one tablet computer power wire and at least one adaptor.

### FIELD OF THE INVENTION

The present invention is related to a multi-functional bag, and in particular to a multi-functional electronic device receiving bag.

### BACKGROUND OF THE INVENTION

With the progress of technology, more and more mobile devices, such as handsets, notebooks, tablet computers, etc. are used. These mobile devices are light, compact, and portable conveniently and thus users carry them at any time.

These mobile devices are built with batteries, but when the power of the battery exhausts, it is needed to find a power socket for charging. Generally, a mobile device is built with a battery, but when the power of the battery exhausts, a standby power source is needed, while different kinds of electronic devices, such as a notebook, a handset, etc. have different kinds of standby power source. Therefore, it is very troublesome to prepare many standby power sources for different electronic devices and also is very inconvenient for carrying and charging these standby power sources. The costs for buying these standby batteries or power charging devices are high and frequently the user forgets to carry one of these batteries, while this induce inconvenient to users.

Therefore, the inventor of present invention desires to design a novel device which can resolve the problem encountered in the prior art.

### SUMMARY OF THE INVENTION

Accordingly, the object of the present invention is to provide a multi-functional electronic device receiving bag, wherein a battery is directly installed within a single one battery is equipped with a plurality of plugs so that the battery is suitable for different kinds of electronic devices. The user only needs to prepare and carry one battery and one transformer and only need to charge one battery It is very convenient. Furthermore other things, such as documents, may be placed within the bag body. Further, the present invention also equips with a hub which can convert data between two electronic devices. Furthermore the bag body is combined with a wireless power charging module which serves to charge a handset with a wireless power charging ability. The user only needs to insert the handset to the bag, the handset will be charged automatically.

To achieve above object, the present invention provides a multi-functional electronic device receiving bag, comprising: a bag body having hollow space; a battery built in the bag body and combined to the bag body for charging power to an electronic device; a hub built in the bag body and combined to the bag body; the hub being electrically connected to the battery; the hub including an input port and at least one output port; the input port being connected to an electronic device so that through the input port and the output port of the hub, the electronic device can be connected to other electronic device; the hub being connected to the battery through a power wire so as to having power supplied from the battery; and a wireless power charging module built in the bag body and combined to the bag body; the wireless power charging module being electrically connected to the battery and then transferring power from the battery to an external electronic device wirelessly; the wireless power charging module being at a lateral side of the bag body to have an optimum power supply to other electronic device.

The multi-functional electronic device receiving bag of the present invention further comprises at least one notebook conduction wire connected to the battery for providing power of the battery to a notebook; at least one handset power wire to the battery for providing power of the battery to a handset; and at least one tablet computer power wire to the battery for providing power of the battery to a tablet computer; and an adaptor connecting to the power wire so that other electronic devices may be connected to the power wire through adaptors and then to the battery.

Therefore, the battery can provide power to electronic devices through the notebook conduction wire or the handset power wire or tablet computer power wire; and thereby, the battery is used as a mobile power source; and a user only needs to power an electronic device through the battery in the bag body; and thus the user is unnecessary to carry another mobile power source.

### BRIEF DESCRIPTION OF THE DRAWINGS

FIG. 1 shows the one embodiment of the present invention.

FIG. 2 is a structural block diagram of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

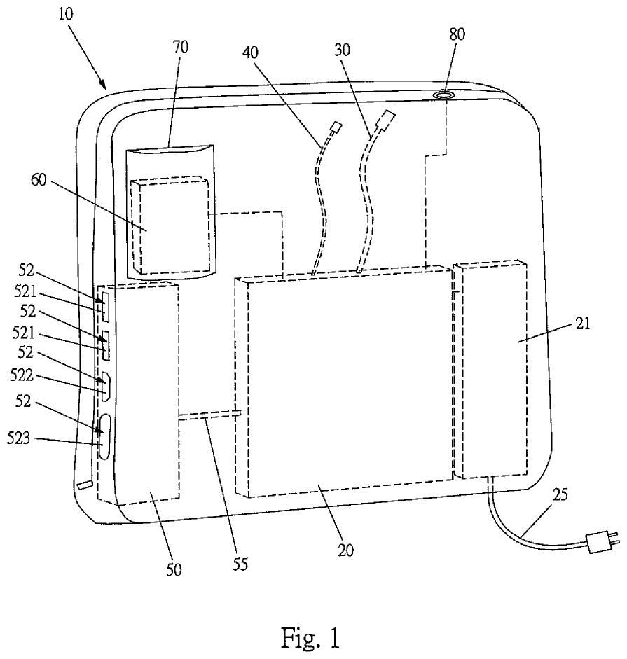

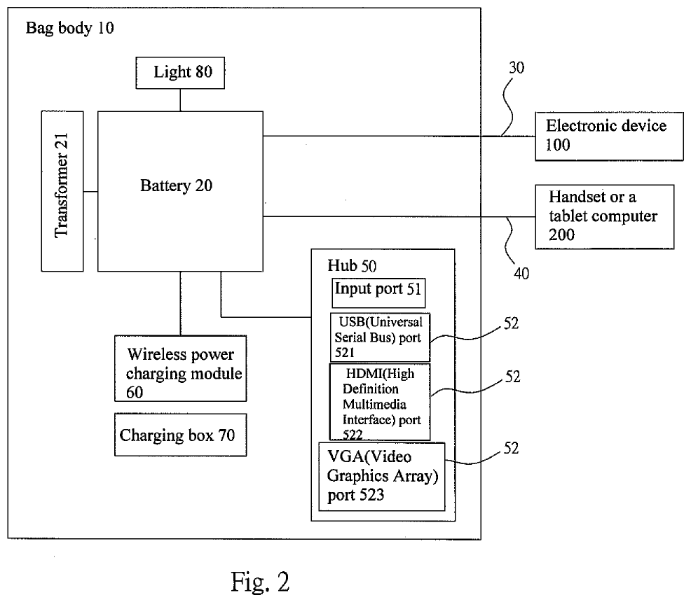

With reference to FIGS. 1 and 2, the structure of the present invention is illustrated. The present invention includes the following elements.

A bag body 10 has hollow space, as illustrated in FIG. 1. The bag body 10 shown in FIG. 1 is only a schematic view of this embodiment, and is not used to confine the scope of the present invention. The bag body 10 may be a bag of various forms, such as a bag for receiving a notebook computer, a bag of postman, a backpack, etc.

The bag body 10 serves to receive an electronic device, such as a notebook computer, or a tablet computer.

A battery 20 is built in the bag body 10 and may be combined to the bag body 10. The battery 20 serves to charge power to an electronic device. Preferable, the battery 20 has a thin and long form and preferably, the battery 20 is a ceramic lithium battery. The battery 20 has a capacity between 3000 mAh to 6000 mAh (mill ampere per hour) to provide sufficient power capacity.

The battery 20 may be quickly charged with 1A to 2A.

In the present invention, a transformer 21 may be built in the bag body 10 for being used with the battery 20.

A power charging wire 25 is connected to the transformer 21 for being connected to an external power source (not shown).

At least one notebook conduction wire 30 is connected to the battery 20 for providing power of the battery 20 to external notebook (not shown).

At least one handset or tablet computer power wire 40 is connected to the battery 20 for providing power of the battery 20 to a handset or a tablet computer 200.

Other electronic devices may be connected to the power wire 40 through adaptors.

The battery 20 may provide power to the electronic device 100 through the notebook conduction wire 30 or the handset or tablet computer power wire 40. Thereby, the battery 20 is used as a mobile power source. A user only needs to power an electronic device 100 through the battery 20 in the bag body 10. The user is unnecessary to carry another mobile power source. It is convenient.

A hub 50 is built in the bag body 10 and is combined to the bag body 10 as an integral structure. The hub 50 is electrically connected to the battery 20. The hub 50 includes an input port 51 and at least one output port 52. The input port 51 is connected to an electronic device so that through the input port 51 and the output port 52 of the hub 50, the electronic device 100 can be connected to other electronic device. Preferably, the input port 51 is a USB (Universal serial bus) port. The at least one output port 52 exposes out of the bag body 10.

The at least one output port 52 includes a USB (Universal Serial Bus) port 521 for being connected to an external USB device (not shown) such as a USB disk. The at least one output port 52 may be an HDMI (High Definition Multimedia Interface) port 522 for being connected to an external display device, such as a television, a projector, etc. The at least one output port 52 may be a VGA (Video Graphics Array) port 523 for being connected to an external display, such as a projector, etc.

The hub 50 may be connected to the battery 20 through a power wire 55 so as to have power supplied from the battery 20.

The present invention further includes a wireless power charging module 60 which is built in the bag body 10 and is combined to the bag body 10 as an integral structure. The wireless power charging module 60 is electrically connected to the battery 20 and then transfer the power from the battery 20 to an external electronic device (such as a handset) wirelessly. Preferably, the wireless power charging module 60 is at a lateral side of the bag body 10 to have an optimum power supply to other electronic device. Because most of the wireless power charging modules have similar specifications, other electronic device with wireless power charging device can also use the wireless power charging module 60 of the present invention.

A charging box 70 is installed on a surface of the bag body 10 and one side of the charging box 70 is near the wireless power charging module 60. The charging box 70 is hollowed for receiving an external electronic device so that the wireless power charging module 60 may charge the electronic device wirelessly.

A light 80 is connected to the battery 20. The light 80 lights up to show the power capacity of the battery 20. Preferably, the light 80 is an LED light. The light 80 emits different color of light according to the amount of power in the battery 20. Preferably, when the amount of power of the battery 20 is higher than 20%, the light 80 emits blue light; when the amount of power of the battery 20 is lower than 20%, the light 80 emits red light.

Advantage of the present invention is that the battery 20 is directly installed within the bag body 10 which forms as an integral structure. Generally, a mobile device is built with a battery, but when the power of the battery exhausts, a standby power source is needed to prepare, while different kinds of electronic devices, such as a notebook, a handset, etc. have different kinds of standby power source. Therefore, it is very troublesome to prepare many standby power sources for different electronic devices and also is very inconvenient for carrying and charging these standby power sources. In the present invention, a single one battery is equipped with a plurality of plugs so that the battery is suitable for different kinds of electronic devices. The user only needs to prepare and carry one battery and one transformer and only need to charge one battery It is very convenient. Furthermore other things, such as documents, may be placed within the bag body. Further, the present invention also equips with a hub which can convert data between two electronic devices. Furthermore the bag body is combined with a wireless power charging module which serves to charge a handset with a wireless power charging ability. The user only needs to insert the handset to the bag, the handset will be charged automatically.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A multi-functional electronic device receiving bag, comprising:
a bag body having hollow space;
a battery built in the bag body and combined to the bag body for charging power to an electronic device;
a hub built in the bag body and combined to the bag body; the hub being electrically connected to the battery; the hub including an input port and at least one output port; the input port being connected to an electronic device so that through the input port and the output port of the hub, the electronic device can be connected to other electronic device; the hub being connected to the battery through a power wire so as to having power supplied from the battery; and
a wireless power charging module built in the bag body and combined to the bag body; the wireless power charging module being electrically connected to the battery and then transferring power from the battery to an external electronic device wirelessly; the wireless power charging module being at a lateral side of the bag body to have an optimum power supply to other electronic device.

2. The multi-functional electronic device receiving bag as claimed in claim 1, further comprising
at least one notebook conduction wire connected to the battery for providing power of the battery to a notebook;
at least one handset power wire to the battery for providing power of the battery to a handset; and
at least one tablet computer power wire to the battery for providing power of the battery to a tablet computer.

3. The multi-functional electronic device receiving bag as claimed in claim 2, further comprising:
an adaptor connecting to the power wire so that other electronic devices may be connected to the power wire through adaptors and then to the battery; and
wherein the battery can provide power to electronic devices through the notebook conduction wire or the handset power wire or tablet computer power wire; and thereby, the battery is used as a mobile power source; and a user only needs to power an electronic device through the battery in the bag body; and thus the user is unnecessary to carry another mobile power source.

4. The multi-functional electronic device receiving bag as claimed in claim 3, wherein the at least one output port includes a USB port; an HDMI; and a VGA port.

6. The multi-functional electronic device receiving bag as claimed in claim 3, further comprising:
a charging box installed on a surface of the bag body; one side of the charging box being near the wireless power charging module; the charging box being hollowed for receiving an external electronic device so that the wireless power charging module can charge the electronic device wirelessly.

7. The multi-functional electronic device receiving bag as claimed in claim 1, further comprising:
a light connected to the battery for displaying power capacity of the battery.

8. The multi-functional electronic device receiving bag as claimed in claim 1, wherein the light emits different color of light according to the amount of power in the battery.

9. The multi-functional electronic device receiving bag as claimed in claim 1, wherein the bag body is one of a notebook computer bag, a postman bag, and a backpack.

10. The multi-functional electronic device receiving bag as claimed in claim 1, wherein the battery is a ceramic lithium battery.
